(19) United States
(12) Patent Application Publication
(10) Pub. No.: US 2013/0279895 A1
(43) Pub. Date: Oct. 24, 2013

(54) FLATTENABLE TUBULAR CAMERA FLASH DIFFUSER

(71) Applicant: Les Tirmenstein, Dallas, TX (US)

(72) Inventor: Les Tirmenstein, Dallas, TX (US)

(21) Appl. No.: 13/829,380

(22) Filed: Mar. 14, 2013

Related U.S. Application Data
(60) Provisional application No. 61/612,561, filed on Mar. 19, 2012.

(51) Int. Cl. G03B 15/06; G03B 15/03

(52) U.S. Cl. CPC G03B 15/06; G03B 15/03
USPC 396/155; 362/16; 362/18

(57) ABSTRACT

A diffuser for a flash of a hand-held camera, the diffuser including: (A) a sheet material that can be curved, angled, or folded to form a generally tubular shape that can be attached to the flash of the hand-held camera; and (B) means for selectively retaining the sheet material in the generally tubular shape. A method of diffusing a flash of a hand-held camera is also provided, the method comprising the steps of positioning a diffuser according to the invention on the flash of the hand-held camera. The method can include the step of taking flash photography with the hand-held camera with the diffuser on the flash.

### CROSS-REFERENCE TO RELATED APPLICATIONS

This application is a Non-Provisional of U.S. Provisional Application Ser. No. 61/612,561 filed Mar. 19, 2012. The patent application identified herein is incorporated in its entirety by reference for all purposes.

### TECHNICAL FIELD

The inventions generally relate to the field of diffusing the harsh light from the flash of a hand-held camera.

### BACKGROUND

In photography, it is often desirable to diffuse the flash of a hand-held camera. In addition, it is desirable that a device for such a purpose have many characteristics, including, for example, that it be simple to use, small to store, and lightweight. However, these and other desirable features have not been achieved in the marketplace.

An example of a prior effort to address these needs is a product known as the Gary Fong collapsible flash diffuser, which advertises that it provides ease of attachment to various sizes of external flashes, diffuses to about “half cloud” lighting, collapses down to a 1½ inch thick ring allowing for easy storage, and has product dimensions of 5×5×3.5 inches and weighs about 8 ounces.

Among other things, smaller and lighter designs for a camera flash diffuser would be highly desirable.

### BRIEF DESCRIPTION OF THE DRAWING

The accompanying drawing is incorporated into the specification to help illustrate examples according to the presently most-preferred embodiment of the invention. It should be understood that the figures of the drawing are not necessarily to scale.

FIG. 1 is a perspective view of a typical external flash for a hand-held camera (not shown in the figure), for which some designs can be pivotally adjusted, in this case showing the flash directed to the subject of the photography, which provides a hard direct light.

FIG. 2 is a is a perspective view of a typical external flash for a hand-held camera (not shown in the figure), for which some designs can be pivotally adjusted, in this case showing the flash directed to the subject of the photography, which provides a bounced light off another object, such as a ceiling (not shown in the figure).

FIG. 3 is a perspective view illustrating the step of positioning of a camera flash diffuser according to any embodiment of the invention (for example, the embodiments described below) being positioned on an external flash for a hand held-camera (camera not shown in the figure).

FIG. 4 is a perspective view illustrating a camera flash diffuser according to any embodiment of the invention as positioned on the pivoting portion of a typical external flash, whereby the diffuser can provide soft diffused light through a translucent sheet material forming the body of the diffuser.

FIG. 5 is a perspective view of a first embodiment of a camera flash diffuser according to the invention, wherein the diffuser is about 12 inches high, the diffuser is shown in an assembled, folded condition, and an optional top diffuser portion is shown in an open position.

FIG. 6 is a perspective view of a second embodiment (similar to FIG. 5 except for the height dimension) of a camera flash diffuser according to the invention, wherein the diffuser is about 8 inches high, the diffuser is shown in an assembled, folded condition, and an optional top diffuser portion is shown in an open position.

FIG. 7 is a perspective view of an third embodiment (similar to FIG. 5, except that the heights of the side walls are all the same) of a camera flash diffuser according to the invention, wherein the diffuser is about 12 inches high, the diffuser is shown in an unassembled, sheet condition, and showing the lid-securing tab in either a flattened position or folded down position. The text “FLASHPIPE” (facing the reverse side in this view) is an example of optional branding or other graphical matter (e.g., advertising) that may be on the diffuser.

FIG. 8 is a perspective view of a fourth embodiment (similar to the embodiment shown in FIG. 6 except that the heights of the side walls are all the same) of a camera flash diffuser according to the invention, wherein the diffuser is about 8 inches high, the diffuser is shown in an unassembled, sheet condition, and showing the lid-securing tab in either a flattened position or folded down position.

FIG. 9 is a perspective view of a fifth embodiment (similar to the embodiment shown in FIG. 6 with the front wall being 8″ height, and the rear wall being 10″ height, except without a top flap and tab) of a camera flash diffuser according to the invention, wherein the back side portions of the sheet material (overlapping in this embodiment) are higher than the other sides, the diffuser is about 10 inches high (on the back side), and the diffuser is shown in an unassembled, sheet condition. The text “FLASHPIPE” (facing forward in this view) is an example of optional branding or other graphical matter (e.g., advertising) that may be on the diffuser.

FIG. 10 is a perspective view of a sixth embodiment of a camera flash diffuser according to the invention, wherein the generally tubular body of the diffuser is shown being slipped over an elastic band (e.g., a rubber band) positioned around the head (which can optionally be pivotally adjustable as illustrated) of the external flash of a hand-held camera. Friction resistance between the elastic material (e.g., rubber) of the elastic band and interior surface material of the sheet material of the diffuser body keeps the diffuser in place while allowing for quick and easy installation, adjustment, or removal.

FIG. 11 is a perspective view of a seventh embodiment of a camera flash diffuser according to the invention, wherein the sides are polygonal so that when in an assembled condition, as shown, the diffuser has a shape that approaches being tubular, and wherein the top opening can optionally be slanted as shown.

FIG. 12 is a profile view of the seventh embodiment (shown in FIG. 11) of a camera flash diffuser according to the invention.

FIG. 13 is a view of the seventh embodiment in an unassembled, sheet condition. A slight curve in the top edge of the generally rectangular flattened sheet material provides for slanted stack opening at the top when the sheet material is folded or curved into a tubular shape as illustrated in FIG. 11. FIG. 11 illustrates an example of suitable fasteners being hook-and-loop fasteners (such as VELCRO™ fasteners), which in this embodiment are corresponding and cooperating dots of hooks and loops, respectively, positioned on the sheet material on the overlapping back side portions of the sheet material. The text “FlashPipe” (facing forward in this view, not shown in FIG. 11) is an example of optional branding or other graphical matter (e.g., advertising) that may be on the diffuser.

FIG. 14 is an illustration an a lid or “hat” for a generally-cylindrical shape of a diffuser according to yet another embodiment of the invention. In this eighth embodiment, the diffuser is cylindrical with an essentially flat or squared-off top, as illustrated. A pie-shaped cut-out allows for a flat, generally circular or disc-shaped sheet material to be formed into a three-dimensional, concave “hat” for closing the round, other-wise open end of a cylindrical diffuser body. A cooperative arrangement of tabs and attachments (such as cooperative VELCRO® dots can be used to help hold or secure the hat in position on the diffuser.

### SUMMARY OF THE INVENTION

It is desirable to have smaller and lighter designs for a camera flash diffuser for use with a flash of a hand-held camera.

A diffuser for a flash of a hand-held camera, the diffuser including:

(A) a sheet material that can be curved, angled, or folded to form a generally tubular shape that can be attached to the flash of the hand-held camera; and

(B) means for selectively retaining the sheet material in the generally tubular shape.

In combination, an external flash for a hand-held camera and a diffuser for the external flash, the diffuser including:

(A) a sheet material that can be curved, angled, or folded to form a generally tubular shape that can be attached to the flash of the hand-held camera; and

(B) means for selectively retaining the sheet material in the generally tubular shape;

wherein the diffuser is positioned on the external flash. In an embodiment, the external flash is pivotally adjustable, and the diffuser is mounted on the pivoting portion of the external flash.

A method of diffusing a flash of a hand-held camera is also provided, the method comprising the steps of positioning a diffuser according to the invention on the flash of the hand-held camera. The method can include the step of taking flash photography with the hand-held camera with the diffuser on the flash.

The features and advantages of the present invention will be apparent to those skilled in the art. While numerous changes may be made by those skilled in the art, such changes are within the spirit of the invention.

### DETAILED DESCRIPTION OF PRESENTLY PREFERRED EMBODIMENTS AND BEST MODE

### General Definitions and Usages

The words “comprise,” “containing,” and “include” and all grammatical variations thereof are intended to have an open, non-limiting meaning. For example, a composition comprising one component does not exclude the composition having additional components, an apparatus having an element or part does not exclude additional elements or parts, and a method having a step does not exclude methods having additional steps.

While compositions, apparatuses, and methods are described in terms of “comprising,” “containing,” or “including” various components, parts, or steps, the compositions, apparatuses, and methods are that “consist essentially of” or “consist of” the various components, parts, and steps are specifically included and disclosed.

The indefinite articles “a” or “an” mean one or more than one of the component, part, or step that the article introduces.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

Terms such as “first,” “second,” “third,” etc. are assigned arbitrarily and are merely intended to differentiate between two or more components, parts, or steps that are similar or corresponding in nature, structure or function, or action. For example, the words “first” and “second” serve no other purpose and are not part of the name or description of the following name or descriptive terms. Further, the mere use of the term “first” does not require that there be any “second” similar or corresponding component, part, or step. Similarly, the mere use of the word “second” does not require that there by any “first” or “third” similar or corresponding component, part, or step.

### PRESENTLY PREFERRED EMBODIMENTS

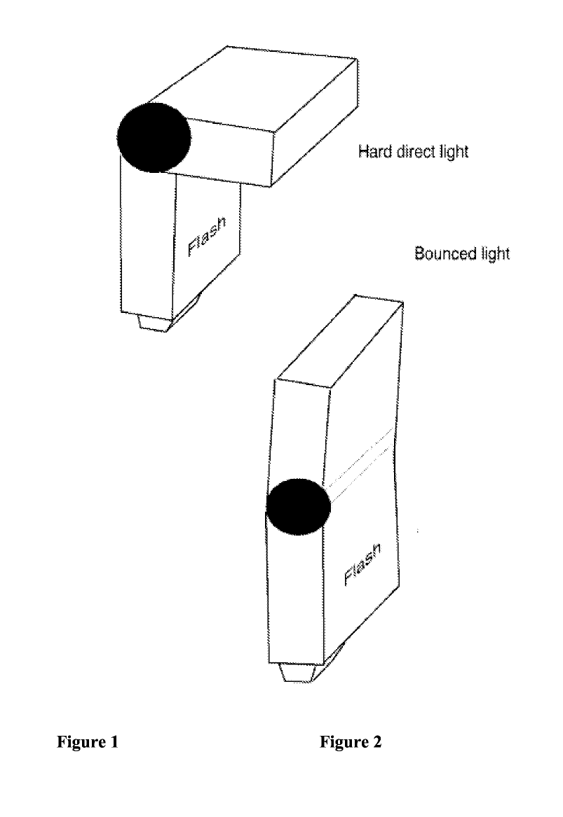

FIG. 1 is a perspective view of a typical external flash for a hand-held camera (not shown in the figure), for which some designs can be pivotally adjusted, in this case showing the flash directed to the subject of the photography, which provides a hard direct light.

FIG. 2 is a is a perspective view of a typical external flash for a hand-held camera (not shown in the figure), for which some designs can be pivotally adjusted, in this case showing the flash directed to the subject of the photography, which provides a bounced light off another object, such as a ceiling (not shown in the figure).

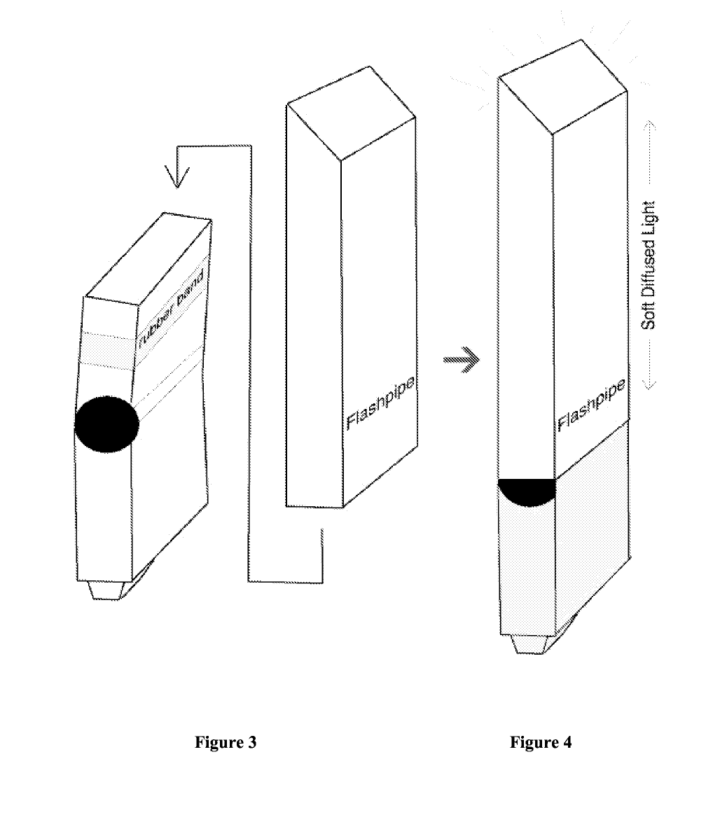

FIG. 3 is a perspective view illustrating the step of positioning of a camera flash diffuser according to any embodiment of the invention (for example, the embodiments described below) being positioned on an external flash for a hand held-camera (camera not shown in the figure).

FIG. 4 is a perspective view illustrating a camera flash diffuser according to any embodiment of the invention as positioned on the pivoting portion of a typical external flash, whereby the diffuser can provide soft diffused light through a translucent sheet material forming the body of the diffuser.

### Construction of Diffuser

According to an embodiment, a camera flash diffuser is constructed of a sheet material that can be curved, angled, or folded to form a generally tubular shape that can be attached to the flash of a hand-held camera. These are particularly useful with external flash units, such as hot-shoe or clip-on external flash units. External flash units are commonly associated with larger 35 mm or digital style cameras having a full frame for hand-holding of the camera and supporting a telephoto lens and external flash. As described in more detail below, the generally tubular shape can be, for example, square, polygonal, or round.

The sheet material is selected for diffusing the harsh light of a flash used with a hand-held camera. This helps provide a diffused, soft, attractive lighting for the taking of a photograph. The generally tubular shape can help create a larger light source than the camera flash. A “pipe” design can elongate the light source.

The generally tubular shape may optionally have a portion at one end that can be bent or folded to close the end of the generally tubular shape. When closed, this helps diffuse the flash light source. When open, some of the light from the flash is directed in the axial direction of the generally tubular shape, which can be used, for example, to bounce some of the flash light source off a ceiling or other overhead structure. In addition to providing diffusion of light 360° around the axis of the generally tubular shape, the open end can provide what is known in photography as a “ceiling wash” effect.

Various shape designs and sizes of a camera flash diffuser according to the invention are contemplated. For example, specific shapes and sizes can be adapted to fit specific brands and models of commercially available camera flash. However, the flexible sheet material also allows a single design to be adapted and adjustable for more than one specific brands and models of camera flash equipment.

The sheet material can be held in a desired shape by various means as will be described in more detail. The size and shape of the article is adapted to attach to a flash on a hand-held camera. The sheet material and other construction materials are lightweight, such that when attached to the flash of a camera rig it will not tip over the flash of a camera rig or significantly alter the weight of the camera rig for the cameraman. For example, the device can weigh less than 2 ounces. It is not cumbersome or a distraction to the cameraman's operation of the camera.

The article can be quickly folded between a flat article to a generally tubular shape and back again, multiple times, as desired.

Preferably, the article has no or very few moving parts, except for folding or flattening of the sheet material. Thus, the article is easy to take out, fold into shape, attach to a flash on a hand-held camera, remove from the flash, fold down to a flattened shape, and store in a cloths pocket or camera bag pocket or next to the camera in the camera bag. The article is easy to assemble, easy to remove, easy to clean, easy to operate, and simple in design and simple to manufacture.

Accordingly, the article can be foldable, collapsible, and space saving when not in use. For example, when folded flat, the article can fit in a camera bag pocket or in a suit or pant pocket. Preferably, the design is elegantly simple.

### Sheet Material

According to an embodiment, a camera flash diffuser is constructed based on a partially translucent sheet material. The sheet material should be sufficiently stiff that a piece of the sheet material that is less than 1/16^{th} inch thick (and preferably less than 1/32^{nd} inch thick) and at least 12 inches high can stand on an edge without vertical support. The material should be foldable, at least along a preformed crease or score in the material. Preferably, the material is still somewhat flexible to bending without breaking or shattering.

In addition, preferable characteristics of the sheet material include that it be tough and durable or resistant to rough handling, repeated folding, or tearing by hand. More preferably, it is practically indestructible to regular folding and use as intended with a camera and carrying in one's pocket. Preferably, the material is easy to clean, for example, by wiping or cleaning with a cloth moistened with water, soap liquid, or other common cleaning fluid. The sheet material can be clear, but it is highly desirable that the sheet material be white in color for better diffusing the harsh light of a flash light source used in camera work; however, soft color hues may be useful in specialized camera lighting uses.

For example, the sheet material can be of a thermoplastic material. The sheet material can be selected from the group consisting of: polypropylene, polyethylene, and para-aramid. Examples of aramids include commercially available materials such as NOMEX™, and TECHNORA™, and KEVLAR™.

Preferably, die-cut fold lines can be formed in the sheet material to help with the guiding or folding of the sheet material to form a desired shape when folded into a position for use or when flattened for storage.

Preferably, the sheet material can accept laser cutting to define graphical material, such as a trade name or logo for the article or other purposes as may be desired.

### Attachment or Means for Selectively Retaining

The sheet material is selectively held into a generally-tubular shape position by any of a variety of possible attachments or means for selectively retaining. For example, the means for selectively retaining can include at least one hook-and-loop fastener operatively connected to the sheet material. According to another example, the means for selectively retaining comprises a pair of magnets operatively connected to the sheet material. According to yet another example, the means for selectively retaining comprises an elastic band that can be positioned around the generally tubular shape formed by the sheet material.

According to a preferred embodiment, for example, a portion of the sheet material is overlapping with another portion of the sheet material when formed into the desired, generally-tubular shape for use with a camera flash. This provides overlapping surfaces of the sheet material on which any of various attachments can be employed. Preferably, the attachments on such overlapping surfaces are temporary, releasable, and reusable.

An example of an attachment is one or more hook-and-loop fasteners, such as VELCRO™. Such hook-and-loop fasteners can be of any convenient shape and position, such as dots or squares that provide sufficient attachment strength to hold the sheet material in the desired generally-tubular shape. For example, several hook-and-loop fasteners may be used, each having a contact area of about ½ square inch, for a total of about 2 square inches. Alternatively, a single strip of such hook-and-loop fastener material along an overlapping surface of the sheet material is contemplated.

Another example of an attachment is a magnetic attachment, such as a rare earth neodymium magnet, which may have shapes and surface contact areas similar as that described for hook-and-look fasteners. An advantage of magnetic attachment is that it may be quieter than a hook-and-loop fastener, which tends to make a ripping sound when separated. This can be distracting in certain settings, such as wildlife photography or events where distracting noise would be undesirable, such as at conferences or wedding services.

Yet another example of an attachment for holding the sheet material into a desired generally tubular shape is a simple elastic band, such as a rubber band, that can be selectively slipped over the generally tubular shape. The elastic band can be removed when it is desired to flatten the article for storage, or, more preferably, can be sufficiently elastic to allow the sheet material to be flattened while the band remains in place. Advantages of the elastic band would be ease of use, highly repeatable use, simplicity, quiet operation, and low manufacturing cost. Depending on position, the elastic band can help retain the article when in a generally tubular shape positioned on the flash of a camera. If desired, the elastic band can have a graphic, such as a trade name or logo imprinted thereon for advertising or other purposes.

### EXAMPLES

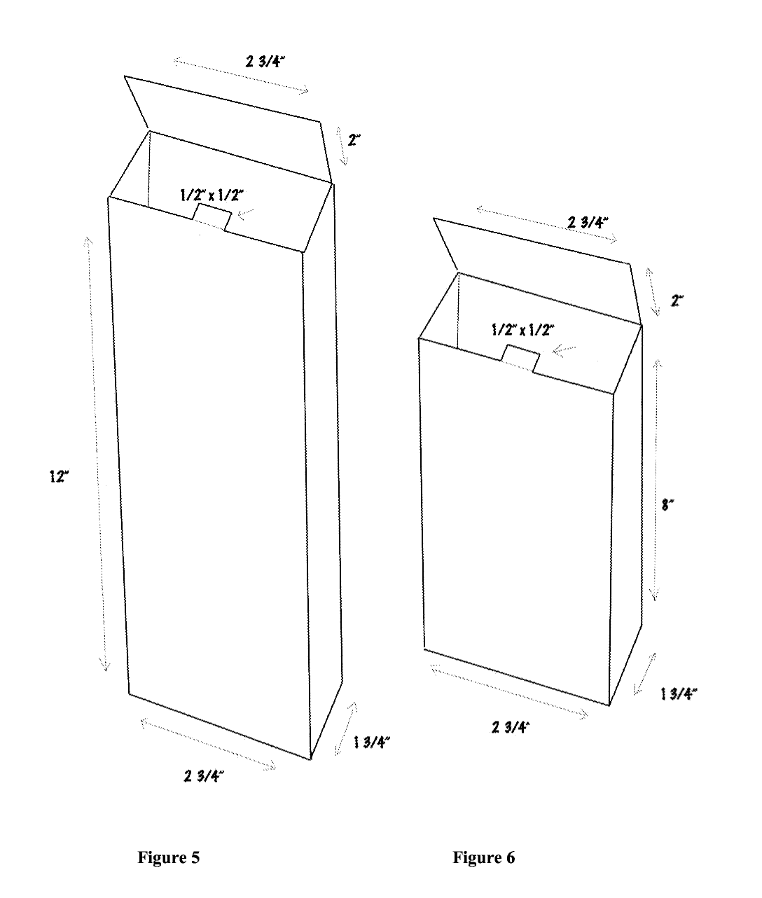

FIG. 5 is a perspective view of a first embodiment of a camera flash diffuser according to the invention, wherein the diffuser is about 12 inches high, the diffuser is shown in an assembled, folded condition, and an optional top diffuser portion is shown in an open position. More particularly, a sheet material is folded into a rectangular tubular shape having a based that is 2¾″ wide, 1¾″ deep, and 12″ high, as shown. In addition, a top flap of the sheet material can be used to optionally close the top of the tubular shape. A smaller tab of the sheet material that is ½″×½″ can be used for an attachment (not shown) to the top flap, which can be used to keep the top flap in a closed position, if desired. If desired, the back wall of the tubular shape can be designed and formed to be slightly higher than the front wall, as indicated in the figure. Thus, the top flap may need to be a bit deeper, e.g., about 2 inches as shown, to close the angled top of the tubular shape.

FIG. 6 is a perspective view of a second embodiment (similar to FIG. 5 except for the height dimension) of a camera flash diffuser according to the invention, wherein the diffuser is about 8 inches high, the diffuser is shown in an assembled, folded condition, and an optional top diffuser portion is shown in an open position. Comparing the first and second embodiments illustrates, for example, that the designs can have a desirable height ranging from just a few inches, e.g., about 3 inches, up to about 18 inches, but preferably in a narrower range of about 4 inches to about 12 inches.

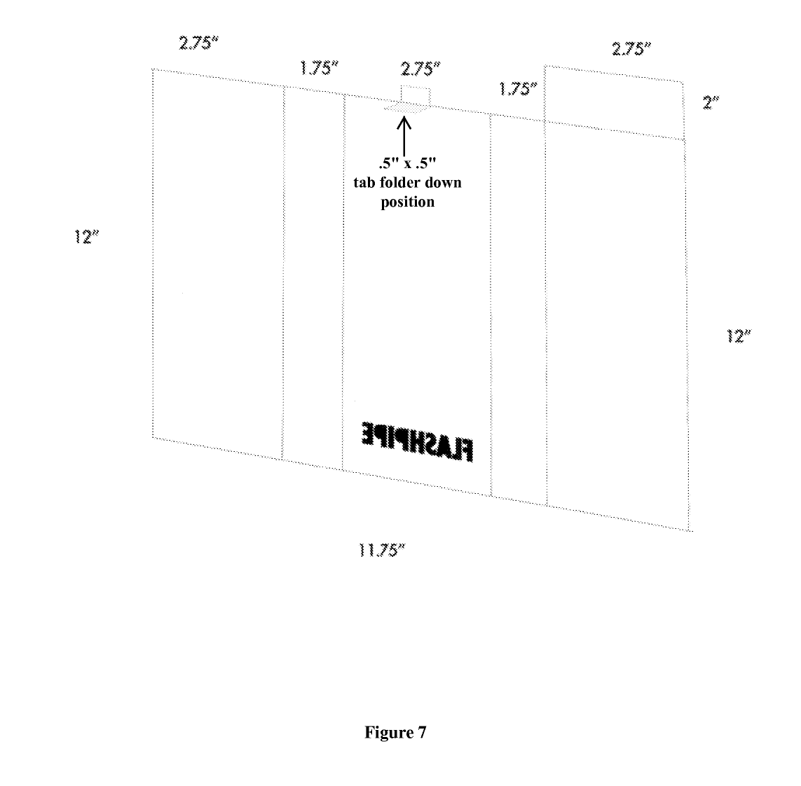

FIG. 7 is a perspective view of an third embodiment (similar to FIG. 5, except that the heights of the side walls are all the same) of a camera flash diffuser according to the invention, wherein the diffuser is about 12 inches high, the diffuser is shown in an unassembled, sheet condition, and showing the lid-securing tab in either a flattened position or folded down position. In addition, the text “FLASHPIPE” (facing the reverse side in this view) is an example of optional branding or other graphical matter (e.g., advertising) that may be on the diffuser. More particularly, the outline of the sheet material is generally rectangular except for the extending top flap and tab, as illustrated. The interior lines are score or crease lines, along which the sheet material can be folded to form a generally tubular shape for use. No attachment is illustrated in FIG. 7, but an attachment would be required to hold the sheet material in the folded shape.

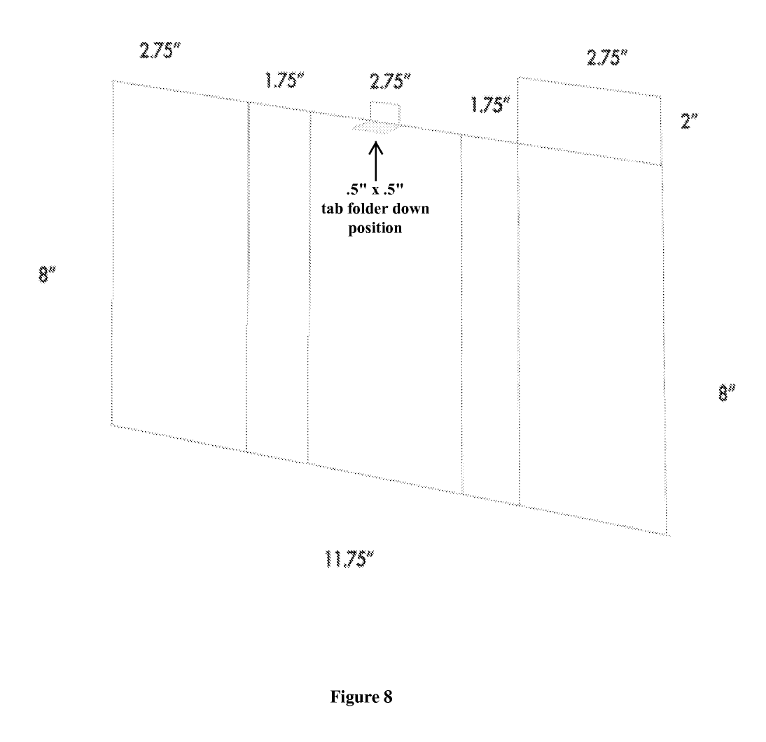

FIG. 8 is a perspective view of a fourth embodiment (similar to the embodiment shown in FIG. 6 except that the heights of the side walls are all the same) of a camera flash diffuser according to the invention, wherein the diffuser is about 8 inches high, the diffuser is shown in an unassembled, sheet condition, and showing the lid-securing tab in either a flattened position or folded down position. More particularly, the outline of the sheet material is generally rectangular except for the extending top flap and tab, as illustrated. The interior lines are score or crease lines, along which the sheet material can be folded to form a generally tubular shape for use. No attachment, such as hook-and-loop fastener or rubber band, is illustrated in FIG. 4, but an attachment would be required to hold the sheet material in the folded shape.

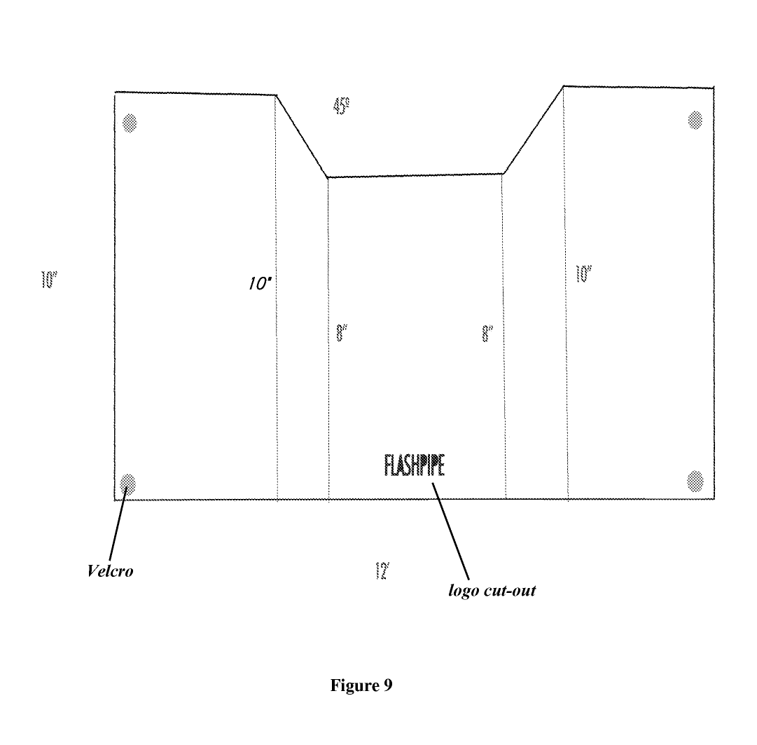

FIG. 9 is a perspective view of a fifth embodiment (similar to the embodiment shown in FIG. 6 with the front wall being 8″ height, and the rear wall being 10″ height, except without a top flap and tab) of a camera flash diffuser according to the invention, wherein the back side portions of the sheet material (overlapping in this embodiment) are higher than the other sides, the diffuser is about 10 inches high (on the back side), and the diffuser is shown in an unassembled, sheet condition. More particularly, the outline of the sheet material is generally rectangular, except for the indentation defining the shorter front wall and the angles at the tops of the side walls, as illustrated. No top flap is included in this particular embodiment. The interior lines are score or crease lines, along which the sheet material can be folded to form a generally tubular shape for use. The text “FLASHPIPE” (facing forward in this view) is an example of optional branding or other graphical matter (e.g., advertising) that may be on the diffuser. FIG. 9 illustrates an example of suitable fasteners being hook-and-loop fasteners (such as VELCRO™ fasteners), which in this embodiment are corresponding and cooperating dots positioned on the sheet material on the overlapping back side portions of the sheet material.

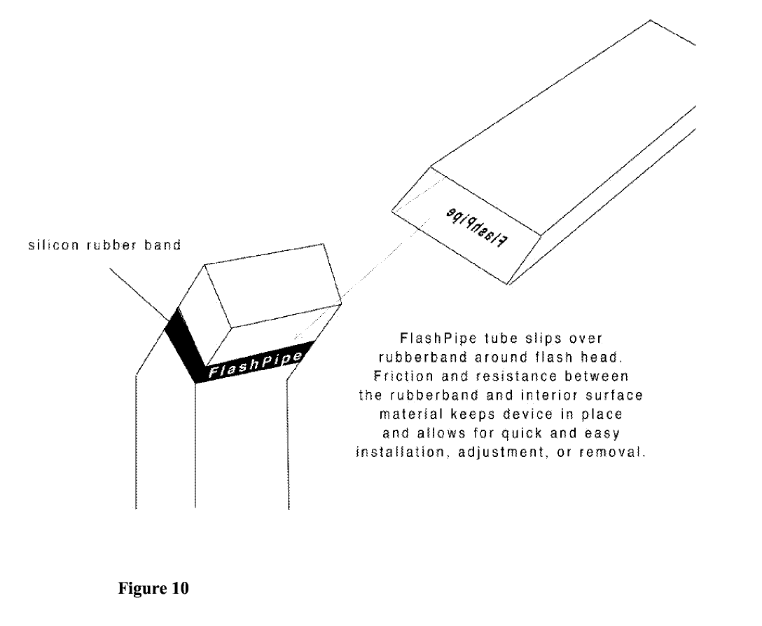

FIG. 10 is a perspective view of a sixth embodiment of a camera flash diffuser according to the invention, wherein the generally tubular body of the diffuser is shown being slipped over an elastic band (e.g., a rubber band) positioned around the head (which can optionally be pivotally adjustable as illustrated) of the external flash of a hand-held camera. Friction resistance between the elastic material (e.g., rubber) of the elastic band and interior surface material of the sheet material of the diffuser body keeps the diffuser in place while allowing for quick and easy installation, adjustment, or removal.

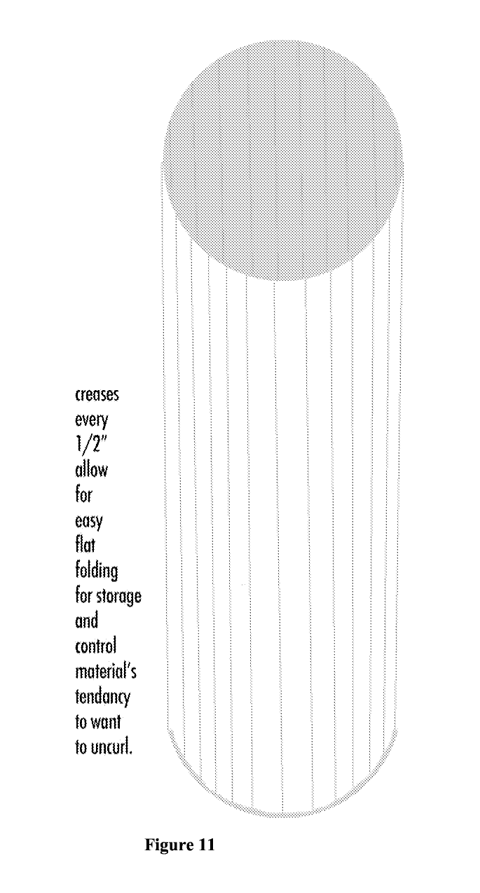

FIG. 11 is a perspective view of a seventh embodiment of a camera flash diffuser according to the invention, wherein the sides are polygonal so that when in an assembled condition, as shown, the diffuser has a shape that approaches being tubular, and wherein the top opening can optionally be slanted as shown. Creases at every ½″ are formed to allow for easy flat folding for storage and control of the tendency of the sheet material to uncurl. Attachment is not illustrated in this figure, but could include, for example, a hook-and-loop fastener on an overlapping portion of the sheet material forming the tubular shape, or could include, for example, an elastic band encircling the tubular shape.

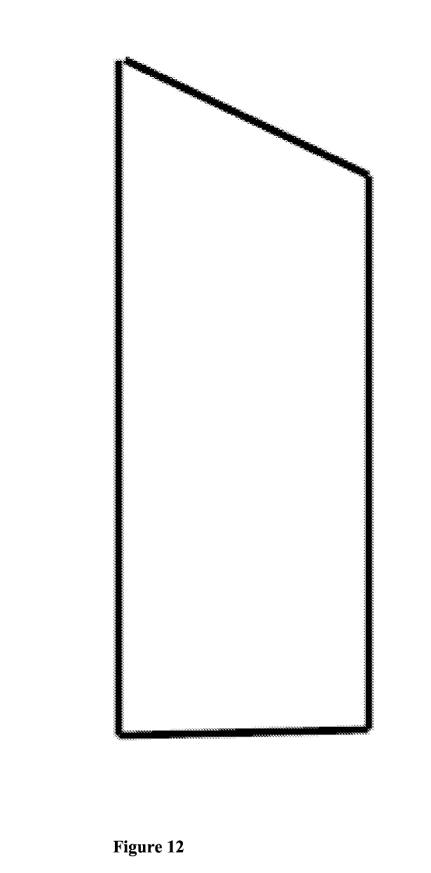

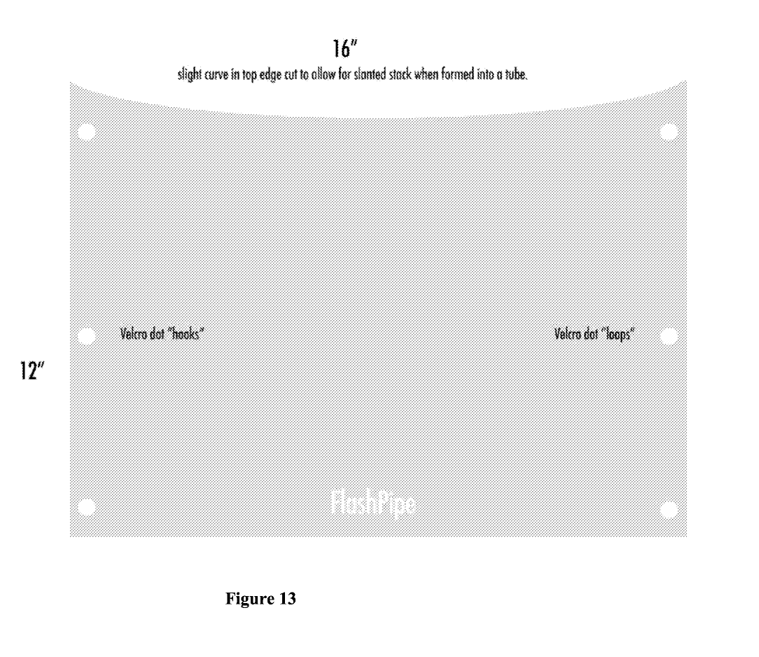

FIG. 12 is a profile view of the seventh embodiment (shown in FIG. 11) of a camera flash diffuser according to the invention.

FIG. 13 is a view of the seventh embodiment in an unassembled, sheet condition. A slight curve in the top edge of the generally rectangular flattened sheet material provides for slanted stack opening at the top when the sheet material is folded or curved into a tubular shape as illustrated in FIG. 11. FIG. 11 illustrates an example of suitable fasteners being hook-and-loop fasteners (such as VELCRO™ fasteners), which in this embodiment are corresponding and cooperating dots of hooks and loops, respectively, positioned on the sheet material on the overlapping back side portions of the sheet material. The text “FlashPipe” (facing forward in this view, not shown in FIG. 11) is an example of optional branding or other graphical matter (e.g., advertising) that may be on the diffuser.

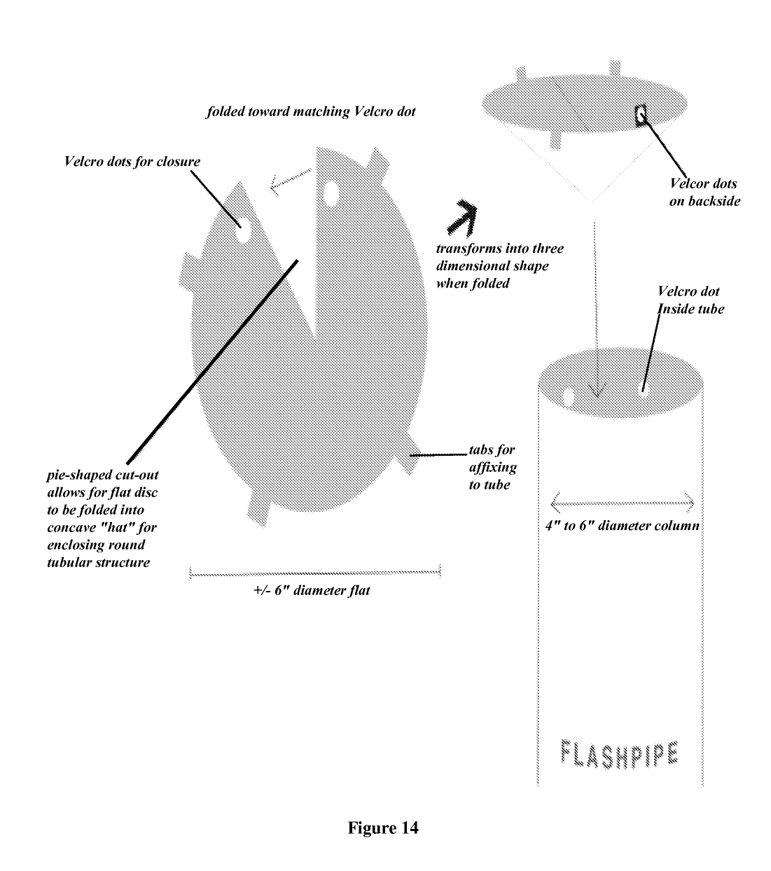

FIG. 14 is an illustration an a lid or “hat” for a generally-cylindrical shape of a diffuser according to yet another embodiment of the invention. In this eighth embodiment, the diffuser is cylindrical with an essentially flat or squared-off top, as illustrated. A pie-shaped cut-out allows for a flat, generally circular or disc-shaped sheet material to be formed into a three-dimensional, concave “hat” for closing the round, other-wise open end of a cylindrical diffuser body. A cooperative arrangement of tabs and attachments (such as cooperative VELCRO® dots can be used to help hold or secure the hat in position on the diffuser.

### CONCLUSION

Therefore, the present invention is well adapted to attain the ends and advantages mentioned as well as those that are inherent therein.

The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention.

The various elements or steps according to the disclosed elements or steps can be combined advantageously or practiced together in various combinations or sub-combinations of elements or sequences of steps to increase the efficiency and benefits that can be obtained from the invention.

The invention illustratively disclosed herein suitably may be practiced in the absence of any element or step that is not specifically disclosed or claimed.

Also, the terms in the claims have their plain, ordinary meaning unless otherwise explicitly and clearly defined by the patentee.

If there is any conflict in the usages of a word or term in this specification and one or more patent(s) or other documents that may be incorporated herein by reference, the definitions that are consistent with this specification should be adopted.

No limitations are intended to the details other than as described in the claims below.

What is claimed is:

1. A diffuser for a flash of a hand-held camera, the diffuser comprising:
(A) a sheet material that can be curved, angled, or folded to form a generally tubular shape that can be attached to the flash of the hand-held camera; and
(B) means for selectively retaining the sheet material in the generally tubular shape.

2. The diffuser according to claim 1, wherein the generally tubular shape selected from the group consisting of square, polygonal, and round.

3. The diffuser according to claim 1, wherein the sheet material is translucent.

4. The diffuser according to claim 1, wherein the sheet material is sufficiently stiff that a piece of the sheet material that is less than 1/16^{th} inch thick (and preferably less than 1/32^{nd} inch thick) and at least 12 inches high can stand on an edge without vertical support.

5. The diffuser according to claim 1, wherein the material is foldable.

6. The diffuser according to claim 1, wherein the sheet material has at least one preformed score for making folding or bending of the sheet material along the score easier.

7. The diffuser according to claim 1, wherein the sheet material is flexible to bending without breaking or shattering.

8. The diffuser according to claim 1, wherein the sheet material is tough and durable or resistant to rough handling, repeated folding, or tearing by hand.

9. The diffuser according to claim 1, wherein the sheet material is resistant to regular folding and use as intended with a camera and carrying in a pocket.

10. The diffuser according to claim 1, wherein the sheet material is can be cleaned by wiping or cleaning with a cloth moistened with water, soap liquid, or other cleaning fluid.

11. The diffuser according to claim 1, wherein the sheet material is white in color.

12. The diffuser according to claim 1, wherein the sheet material is a thermoplastic material.

13. The diffuser according to claim 1, wherein the sheet material is selected from the group consisting of: polypropylene, polyethylene, and para-aramid.

14. The diffuser according to claim 1, wherein the sheet material can accept laser cutting to define graphical material, such as a trade name or logo for the article or other purposes as may be desired.

15. The diffuser according to claim 1, wherein the means for selectively retaining comprises at least one hook-and-loop fastener operatively connected to the sheet material.

16. The diffuser according to claim 1, wherein the means for selectively retaining comprises a pair of magnets operatively connected to the sheet material.

17. The diffuser according to claim 1, wherein the means for selectively retaining comprises an elastic band that can be positioned around the generally tubular shape formed by the sheet material.

18. In combination, an external flash for a hand-held camera and a diffuser for the external flash, wherein the diffuser is according to claim 1, and wherein the diffuser is positioned on the external flash.

19. The combination according to claim 18, wherein the external flash is pivotally adjustable, and the diffuser is mounted on the pivoting portion of the external flash.

20. A method of diffusing a flash of a hand-held camera, the method comprising the steps of:
(A) positioning a diffuser according to claim 1 on the flash of the hand-held camera.

21. The method according to claim 20, further comprising the step of: taking flash photography with the hand-held camera with the diffuser on the flash.
